(19) United States
(12) Patent Application Publication
(10) Pub. No.: US 2026/0330494 A1
(43) Pub. Date: Oct. 22, 2026

(54) ELECTRONIC COMMERCE SYSTEM

(71) Applicant: Akiteru MATSUMOTO, Saitama (JP)

(72) Inventor: Akiteru MATSUMOTO, Saitama (JP)

(21) Appl. No.: 19/105,663

(22) PCT Filed: Oct. 7, 2022
(86) PCT No.: PCT/JP2022/037674

§ 371 Date: Feb. 21, 2025

(51) Int. Cl. G06Q 30/0207; G06Q 30/0601

(52) U.S. Cl. CPC G06Q 30/0222; G06Q 30/0641

(57) ABSTRACT

The electronic commerce system 1 is a Cloud-based EC System, which is composed of a cloud e-commerce platform server 2 (hereinafter referred to as “Cloud EC Platform Server”), a network 3 such as the Internet or, LAN, multiple seller terminals 4a, 4b, 4c . . . , and multiple purchaser terminals 5a, 5b, 5c . . . The cloud e-commerce platform server 2 is further equipped with an automatic price adjustment function that automatically modifies the transaction prices of products during electronic commerce transactions conducted through the EC sites based on the type of coupon used and the remaining time until a specified period ends.

### TECHNICAL FIELD

The present invention relates to an electronic commerce system that enables electronic commerce transactions of products between sellers and purchasers.

### BACKGROUND TECHNOLOGY

In recent years, online shopping, in which products are sold over the Internet, has become increasingly popular. In addition, an increasing number of purchasers are using websites commonly referred to as electronic shopping malls or electronic shopping marketplaces, which aggregate product sales pages from multiple sellers into a single site to offer a wide variety of goods.

Various technologies have been proposed to improve transaction methods, payment methods, and operational methods in electronic shopping malls. For example, Patent Document 1 discloses a technology for an electronic mall system, wherein a framework utilizing a plug-in system is provided under a mall-based proxy sales model, enabling electronic store operators to define store information and product information by allowing the rapid addition and updating of store and product information.

For a product seller to sell products in an electronic shopping mall, they must first apply to the administrator of the shopping site that constitutes the electronic shopping mall to open a store. For example, an application is submitted by entering the company name, payment information such as the name of the recipient of the sales proceeds, and account to which the proceeds must be transferred, and product information to be sold into the application web page provided by the shopping site. Then, when the operating site grants the product seller to open a store in the electronic shopping mall, a product database for the product seller (hereinafter referred to as “Product DB”) is created on the shopping site operation server. The product seller then operates the terminal to modify the prices of products registered in the Product DB, add or remove products, and sell the products while updating the Product DB as needed.

On the other hand, the shopping site operation server generates a purchase screen consisting of a web screen viewable by the product purchaser via a terminal based on the product seller's Product DB. This purchase screen displays the product name, price, etc., allowing the product purchaser to buy the product by operating the terminal while viewing the purchase screen via the terminal.

### PRIOR ART REFERENCE

### Patent Document

[Patent Document 1] Unexamined Patent Publication No. 2001-67418

### SUMMARY OF THE INVENTION

### Problems to be Solved by the Invention

In the electronic mall system described in Patent Document 1, the product seller operates a terminal to modify the prices of products registered in the product DB, which requires time and effort for price modification operations.

The purpose of the present invention is to provide an electronic commerce system that can improve the convenience of sellers in view of the above situation.

### Means for Solving the Problems

The electronic commerce system of the invention described in Claim 1 is characterized by an electronic commerce site management server connected to a plurality of purchaser terminals via a network, enabling electronic transactions of products between sellers and purchasers and equipped with an automatic price adjustment function that automatically modifies the transaction prices of products during electronic commerce transactions.

The electronic commerce system of the invention described in Claim 2 is characterized by an electronic commerce site management server connected to a plurality of purchaser terminals via a network, enabling electronic transactions of products between sellers and purchasers and equipped with an automatic price adjustment function that automatically modifies the transaction prices of products during electronic commerce transactions based on the type of coupon used and the remaining time until a specified period ends.

The electronic commerce system of the invention described in Claim 3 is the electronic commerce system, according to Claim 1 or 2, characterized in that the right to use the automatic price adjustment function is provided to the seller by means of a plug-in.

### Effect of the Invention

The electronic commerce system of the present invention improves convenience for sellers.

### BRIEF DESCRIPTION OF THE DRAWINGS

FIG. 1 A block diagram illustrating the schematic configuration of the electronic commerce system according to the embodiment of the present invention.

FIG. 2 A flowchart illustrating the process of opening an electronic commerce site in the electronic commerce system according to the embodiment of the present invention.

FIG. 3 A flowchart illustrating the electronic commerce transaction process in the electronic commerce system according to the embodiment of the present invention.

FIG. 4 An illustration showing an example of an electronic commerce transaction screen displayed on a purchaser terminal according to the embodiment of the present invention.

### MODE FOR CARRYING OUT THE INVENTION

### Embodiment of the Present Inventio

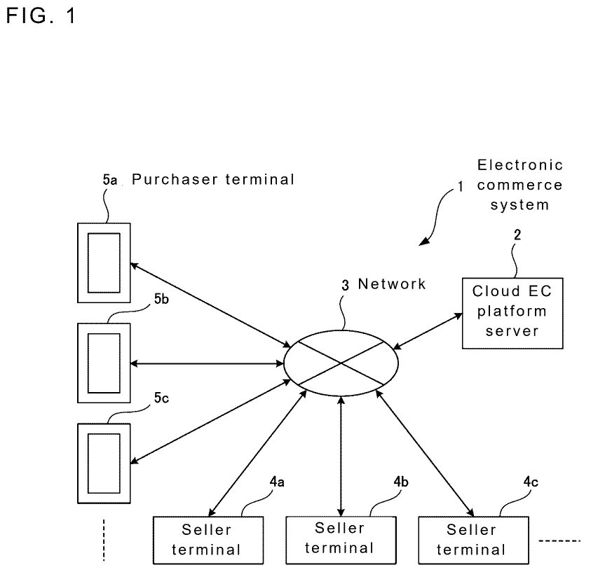

The embodiment of the present invention will be explained in detail with reference to FIG. 1 to FIG. 4. The present embodiment is characterized by the automatic modification of the transaction prices of products in electronic commerce transactions.

### Configuration of the Embodiment

FIG. 1 is a block diagram illustrating the schematic configuration of the electronic commerce system according to the embodiment of the present invention.

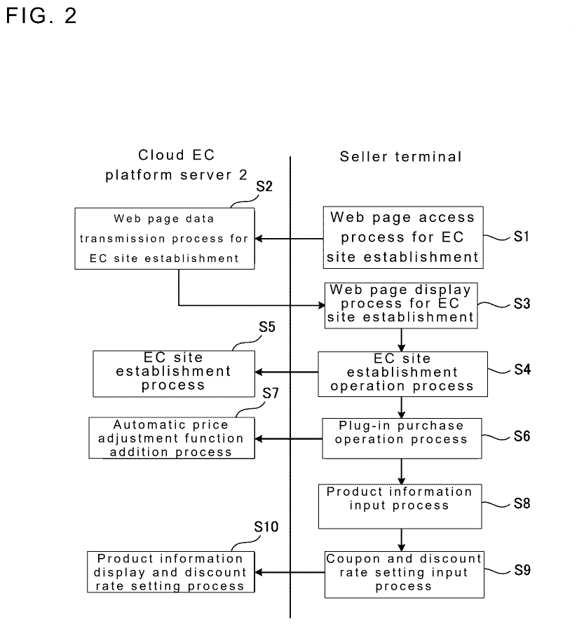

FIG. 2 is a flowchart illustrating the process of opening an electronic commerce site in the electronic commerce system according to the embodiment of the present invention.

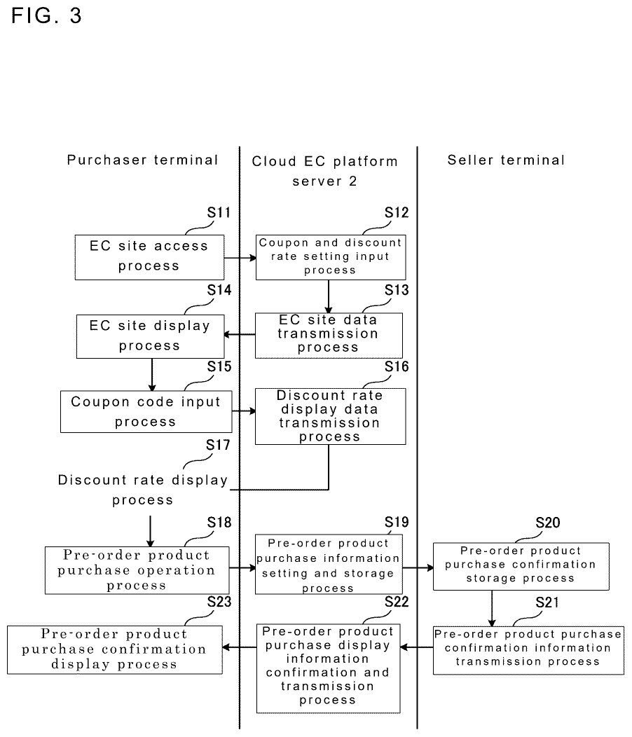

FIG. 3 is a flowchart illustrating the electronic commerce transaction process in the electronic commerce system according to the embodiment of the present invention.

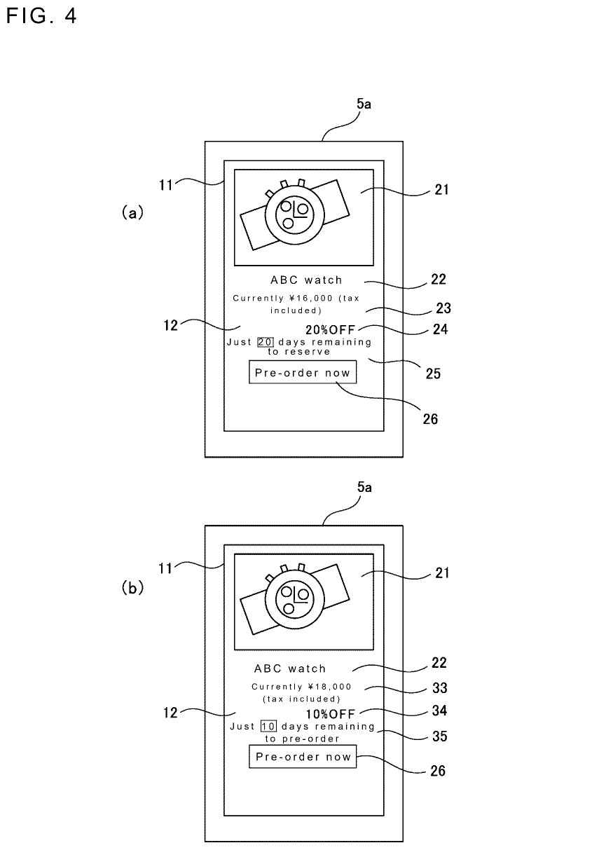

FIG. 4 is an illustration showing an example of an electronic commerce transaction screen displayed on a purchaser terminal according to the embodiment of the present invention.

As shown in FIG. 1, the electronic commerce system 1 (hereinafter referred to as “EC System”) of the present embodiment is a cloud-based EC system equipped with a cloud-based e-commerce platform server 2 (hereinafter referred to as “Cloud EC Platform Server”), a network 3 such as the Internet or, LAN, multiple seller terminals 4a, 4b, 4c . . . , and multiple purchaser terminals 5a, 5b, 5c The multiple seller terminals 4a, 4b, 4c . . . and multiple purchaser terminals 5a, 5b, 5c . . . are not particularly limited to personal computers, tablets, smartphones, or the like, as long as they can be connected to a network.

The cloud EC platform server 2 provides Internet services. It is installed and managed by the company operating the system (the EC site provider) and enables the establishment of multiple electronic commerce sites (hereinafter referred to as “EC sites”).

The seller terminals 4a, 4b, 4c . . . are individually owned by a plurality of sellers and can access the cloud EC platform server 2, enabling them to establish and operate their respective EC sites.

The purchaser terminals 5a, 5b, 5c . . . are individually owned by a plurality of general users (purchasers), and they can conduct transactions of products (paper tickets for concerts, movies, etc.; items such as furniture, home appliances, electronic devices, clothing, food, toys, etc.; services such as legal consultations and postal delivery; rights such as securities; electronic tickets for concerts, movies, etc.; and information such as video content, music content, computer software, apps, etc.) by accessing the cloud EC platform server 2.

The cloud e-commerce platform server 2 is further equipped with an automatic price adjustment function that automatically modifies the transaction prices of products during electronic commerce transactions conducted through EC sites, using coupons or the like, based on the type of coupon used and the remaining time until a specified period ends.

The right to use the automatic price adjustment function is provided to sellers with a plug-in on the cloud EC platform server 2, and the settings of the automatic price adjustment function can be configured through operations on the seller terminals 4a, 4b, 4c . . .

In the present embodiment, the cloud EC platform server 2, a plurality of seller terminals 4a, 4b, 4c . . . and a plurality of purchaser terminals 5a, 5b, 5c . . . are configured from hardware comprising computers and peripheral devices, as well as software that controls the hardware.

The hardware includes a Central Processing Unit (CPU) as a control unit, as well as a storage unit, a communication device, a display device, and an input device. Examples of storage units include memory, such as Random Access Memory (RAM) and Read-Only Memory (ROM), as well as storage devices like Hard Disk Drives (HDD) and optical disk drives, such as Compact Discs (CD) or Digital Versatile Discs (DVD).

Examples of communication devices include various wired and wireless interface devices. Examples of display devices include various types of displays, such as liquid crystal displays (LCDs) and plasma displays. Examples of input devices include touch panels, keyboards, and pointing devices (e.g., mice, trackballs, etc.).

The software mentioned above includes computer programs and data that control the hardware. The computer programs and data are stored in a storage unit and are executed or referenced as needed by a control unit. Additionally, the computer programs and data can be distributed via communication lines or recorded on computer-readable media such as CD-ROMs for distribution.

The following describes the flow of processing executed by the EC system 1 based on the flowcharts in FIG. 2 and FIG. 3.

### EC Site Establishment Process

As shown in FIG. 2, in Step S1, when EC system 1 performs the establishment process of the electronic commerce site, a seller terminal (one among purchaser terminals 5a, 5b, 5c . . . ) accesses the EC site establishment web page provided by the EC site provider, which is uploaded to the cloud EC platform server 2 based on the seller's operation.

As a result, in Step S2, the cloud EC platform server 2 transmits the data from the EC site establishment web page to the seller terminal.

Accordingly, in Step S3, the seller terminal displays the EC site establishment screen via the EC site establishment web page. Subsequently, in Step S4, the seller terminal executes the EC site (e-commerce store) establishment operation process based on the seller's input operations for each field (such as company name, recipient name for sales proceeds, payment destination account, and product information for items to be sold) on the EC site establishment screen and input data for each field is then transmitted to the cloud EC platform server 2.

Next, in Step S5, the cloud EC platform server 2 registers various settings and information for the EC site based on the input data for each field received from the seller terminal and then establishes the EC site. The seller terminal updates various settings and information for the EC site.

After the EC site is established, in Step S6, the seller terminal executes the plug-in purchase operation process to purchase the automatic price adjustment function as a plug-in based on the seller's input operation to add the automatic price adjustment function and transmits the input data for the plug-in purchase operation to the cloud EC platform server 2.

As a result, in Step S7, the cloud EC platform server 2 executes the plug-in addition process for the automatic price modification function on the EC site based on the input data from the plug-in purchase operation from the seller terminal.

Subsequently, in Step S8, the seller terminal executes the input process for product information by the seller. In Step S9, the seller terminal performs the input process for coupon settings, as configured by the seller, including coupon name (e.g., Summer Campaign Coupon, Christmas Coupon), coupon code settings, and the discount rate setting process using the automatic price adjustment function when applying the coupon. The seller terminal then transmits this input data to the cloud EC platform server 2.

As a result, in Step S10, the cloud EC platform server 2 performs the processes of displaying product information, setting coupons, and discount rate setting process using the automatic price adjustment function when applying the coupon.

In this way, electronic commerce is conducted through EC sites after they have been established and configured with various settings.

### Electronic Commerce Transaction Process

As shown in FIG. 3, when EC system 1 performs the electronic commerce transaction process after the EC site has been established, in Step S11, a purchaser terminal (one among purchaser terminals 5a, 5b, 5c . . . ) accesses the EC site uploaded to the cloud EC platform server 2, based on the operation of a prospective seller.

As a result, in Step S12, the cloud EC platform server 2 determines the product information settings and the distribution of coupons (sending coupon codes), as well as the discount rate setting for each product based on the automatic price adjustment function when using such coupons. In Step S13, the EC site data, including product information, coupon codes, and discount rate information when using the coupons, is transmitted to the purchaser terminal.

Coupon codes may be transmitted through EC sites, emails, or other media. Additionally, various settings are possible for the discount rate for each product via the automatic price adjustment function: based on the remaining time until the end of the electronic transaction's restriction period (for example, coupon usage period or product pre-order period), based on the timing of coupon distribution, or based on the timing of coupon usage. In the last case, the coupon's value may change based on the time from distribution to usage (for example, 20% off during the first week and 18% off during the next 2 weeks).

Accordingly, in Step S14, the purchaser terminal displays the EC site screen. Subsequently, in Step S15, when a prospective purchaser wishes to use a coupon, they enter the coupon code using the purchaser terminal on the pre-order product purchase screen of the EC site, and it is then transmitted to the cloud EC platform server 2.

As a result, in Step S16, the cloud EC platform server 2 determines the type of discount rate setting for the product based on the coupon code received from the purchaser terminal. It then calculates the discount rate according to the identified setting type and transmits the data necessary to display the determined discount rate to the purchaser terminal.

Then, in Step S17, the purchaser terminal displays the discount rate for the product on the EC site screen.

Subsequently, in Step S18, the prospective purchaser enters various details on the EC site's pre-order product purchase screen using the purchaser terminal to perform the pre-order product purchase process. The pre-order product purchase information is then transmitted to the cloud EC platform server 2.

Accordingly, in Step S19, the cloud EC platform server 2 records various settings (such as product stock countdown or sales suspension due to stock depletion) and related information based on the pre-order product purchase information from the purchaser terminal. The server then transmits the pre-order product purchase information, along with the recorded settings and information, to the seller terminal.

As a result, in Step S20, the seller terminal performs the pre-order product confirmation process (including determining the product shipping date and various charges) based on the pre-order product purchase information, various settings, and record information from the cloud EC platform server 2. In Step S21, the pre-order product confirmation information is transmitted to EC platform server 2.

Accordingly, in Step S22, the cloud EC platform server 2 updates various records and modifies the display data on the EC site based on the pre-order product confirmation information from the seller terminal. The server then displays the pre-order product confirmation information on the EC site and sends it via email.

As a result, in Step S23, the seller terminal displays the pre-order product confirmation information from the cloud EC platform server 2 on the EC site and also sends the pre-order product confirmation information via email. Based on the pre-order product confirmation information, the seller sets the product for pre-order and upon delivery, ships it to the purchaser's address.

### Electronic Commerce Transaction Process

The screen display of the purchaser terminal is described below with reference to FIG. 4, using purchaser terminal 5a as an example.

As shown in FIG. 4(a) and FIG. 4(b), screen 11 of purchaser terminal 5a displays the purchase screen 12 for the ABC watch as the EC site's purchase screen.

Here, on the EC site, the automatic price adjustment function of the plug-in adjusts the transaction price of the ABC watch based on the remaining time until the end of the electronic commerce transaction restriction period (pre-order period) when a coupon is used.

As a specific example, the restriction period (pre-order period) is set for 31 days, from Sep. 1, 2022, to Oct. 1, 2022. On the pre-order start date, the discount rate is 30%, and the product price (including tax) is ¥14,000. Thereafter, the discount rate decreases by 1% each day as the countdown to the end of the pre-order period progresses. As shown in FIG. 4(a), on Sep. 11, 2022, the discount rate is 20%, and the product price (including tax) is ¥16,000. As shown in FIG. 4(b), on Sep. 21, 2022, the discount rate is 10%, and the product price (including tax) is ¥18,000. Finally, on Oct. 1, 2022, the discount rate reaches 0%, and the product price (including tax) becomes ¥20,000.

As shown in FIG. 4(a), on the purchase screen 12 for the ABC watch on Sep. 11, 2022, the following items are displayed in order from top to bottom: a photo image 21 of the ABC watch, a product name image 22 of the ABC Watch, a text image 23 displaying the current price (¥16,000), a text image 24 showing the current discount rate (20% OFF), a text image 25 indicating the number of days remaining until the pre-order period ends (20 days left), and a pre-order button 26.

As shown in FIG. 4(b), on the purchase screen 12 for the ABC watch on Sep. 21, 2022, the following items are displayed in order from top to bottom: a photo image 21 of the ABC watch, a product name image 22 of the ABC Watch, a text image 33 displaying the current price (¥18,000), a text image 34 showing the current discount rate (10% OFF), a text image 35 indicating the number of days remaining until the pre-order period ends (10 days left), and a pre-order button 26.

In FIG. 4(a) and FIG. 4(b), when a purchaser operates the pre-order button 26, screen 11 transitions to an input screen where the purchaser can enter details such as the delivery address and the number of items.

To summarize the configuration and effects of the embodiment of the present invention, the electronic commerce system 1 comprises an electronic commerce site management server (cloud EC platform server 2) connected to a plurality of purchaser terminals via a network, enabling electronic transactions of products between sellers and purchasers and equipped with an automatic price adjustment function that automatically modifies the transaction prices of products during electronic commerce transactions.

In addition, the electronic commerce system 1 comprises an electronic commerce site management server (cloud EC platform server 2) connected to a plurality of purchaser terminals via a network, enabling electronic transactions of products between sellers and purchasers and equipped with an automatic price adjustment function that automatically modifies the transaction prices of products during electronic commerce transactions based on the type of coupon used and the remaining time until a specified period ends.

Furthermore, electronic commerce system 1 provides the right to use the automatic price adjustment function to the seller by means of a plug-in.

According to the electronic commerce system 1 of this embodiment, the transaction prices of products in electronic commerce, which were previously adjusted manually, can now be adjusted automatically, providing convenience to the seller.

The embodiment of the invention shown in FIG. 1 to FIG. 4 applies the present invention to a cloud-based electronic commerce system, where the EC site is established on the cloud EC platform server 2. However, the system can also be applied to a download-type electronic commerce system, where the seller uses the seller terminal to download a program for establishing the EC site from the program provider's server and uploads the EC site data to a rental server or an in-house server, separate from the program provider's server, to set up the EC site.

Additionally, in the embodiment of the invention shown in FIG. 1 to FIG. 4, electronic commerce transactions between the seller and the purchaser are conducted via a web EC site using web pages. However, the system may also be configured to perform electronic commerce transactions through a dedicated application.

Furthermore, in the embodiment of the invention shown in FIG. 1 to FIG. 4, the pre-order period is set as the restriction period for electronic commerce transactions. However, the restriction period for electronic commerce transactions may also be defined as the period from the start to the end of a limited-time sale.

Furthermore, in the embodiment of the invention shown in FIG. 1 to FIG. 4, the transaction price of the product in electronic commerce transactions is modified using a coupon. However, the transaction prices of products may also be modified without using a coupon.

Furthermore, in the embodiment of the invention shown in FIG. 1 to FIG. 4, the right to use the automatic price adjustment function is provided to the seller through a plug-in. However, the function may also be provided via an app or other software.

Furthermore, in the embodiment of the invention shown in FIG. 1 to FIG. 4, the discount rate for the transaction price in electronic commerce transactions is set to decrease daily. However, transaction price adjustments may be applied in various ways, such as first lowering the discount rate during the transaction period and then increasing it or modifying the discount rate on an hourly basis, among other possible variations.

The devices and means constituting the electronic commerce system of the present invention are not limited to those described above. Depending on the usage purpose of the electronic commerce system, the system may be configured with only the necessary devices and means or supplemented with additional devices and means as needed.

Furthermore, the individual means do not need to be configured separately; they may be integrated into a single means that combines multiple functions. It is also possible to integrate two or more systems into one or, conversely, to construct and connect a single system from two or more separate systems.

For example, the functionality of the seller terminals 4a, 4b, 4c . . . may be shared with the cloud EC platform server 2 on a single computer.

Furthermore, the above embodiment represents merely one of the best or its closest forms currently available.

### INDUSTRIAL APPLICABILITY

The electronic commerce system of the present invention can be effectively utilized by businesses and corporations that provide electronic commerce systems and services, as well as those engaged in electronic commerce.

### EXPLANATION OF THE REFERENCE NUMERALS

1 Electronic commerce system
2 Cloud EC Platform Server
3 Network
4a, 4b, 4c Seller terminals
5a, 5b, 5c Purchaser terminals

1. An electronic commerce system characterized by an electronic commerce site management server connected to a plurality of purchaser terminals via a network, enabling electronic transactions of products between sellers and purchasers;
wherein the electronic commerce system is further equipped with an automatic price adjustment function that automatically modifies the transaction prices of products during electronic commerce transactions.

2. An electronic commerce system characterized by an electronic commerce site management server connected to a plurality of purchaser terminals via a network, enabling electronic transactions of products between sellers and purchasers;
wherein the electronic commerce system is further equipped with an automatic price adjustment function that automatically modifies the transaction price of the products during electronic commerce transactions, based on the type of coupon used and the remaining time until a specified period ends.

3. The electronic commerce system, according to claim 1, characterized in that the right to use the automatic price adjustment function is provided to the seller by means of a plug-in.

4. The electronic commerce system, according to claim 2, characterized in that the right to use the automatic price adjustment function is provided to the seller by means of a plug-in.
